(19) United States
(12) Patent Application Publication
(10) Pub. No.: US 2015/0069038 A1
(43) Pub. Date: Mar. 12, 2015

(54) BI-DIRECTIONAL ENERGY SHARING FOR ENGINE DRIVEN WELDER

(71) Applicant: LINCOLN GLOBAL, INC., City of Industry, CA (US)

(72) Inventors: BRYAN SCOTT BURKHART, CHARDON, OH (US); DARREN STOCKTON, NEWBURY, OH (US)

(73) Assignee: LINCOLN GLOBAL, INC., City of Industry, CA (US)

(21) Appl. No.: 14/100,204

(22) Filed: Dec. 9, 2013

Related U.S. Application Data
(60) Provisional application No. 61/876,799, filed on Sep. 12, 2013.

(51) Int. Cl. B23K 9/10; B23K 9/32

(52) U.S. Cl. CPC B23K 9/1006; B23K 9/1081; B23K 9/327
USPC 219/134

(57) ABSTRACT

The invention described herein generally pertains to a system and method for utilizing a power source of an engine driven welder as a portion of a power supply for a hydraulic device associated with a vehicle. The hydraulic device can be incorporated into a vehicle, a stand-alone device, or a combination thereof. One or more controllers can manage power distribution and identify power sources for the hydraulic device based upon a parameter.

### CROSS-REFERENCE TO RELATED APPLICATIONS

This application claims the benefit of priority to U.S. Provisional Application Ser. No. 61/876,799, filed Sep. 12, 2013, and entitled “BI-DIRECTIONAL ENERGY SHARING FOR ENGINE DRIVEN WELDER.” The entirety of the aforementioned application is incorporated herein by reference.

### TECHNICAL FIELD

The invention described herein pertains generally to a system and method that manages power between a welding device, a vehicle, and a hydraulic device that is partially integrated with the vehicle.

### BACKGROUND OF THE INVENTION

Frequently, welding is required where supply power may not be readily available. As such, the welding power supply may be an engine driven welding power supply incorporating a generator. The generator may supply power to the welder as well as to other power tools as may be needed on site. As different applications require different versions of welders and power tools, the trailer may be designed to carry one of many different types of welding power supplies.

Traditional welding-type apparatus can be broken into two basic categories. The first category receives operational power from transmission power receptacles, also known as static power. The second is portable or self-sufficient, stand alone welders having internal combustion engines, also known as rotating power. While in many settings conventional static power driven welders are preferred, engine driven welders enable welding-type processes where static power is not available. Rotating power driven welders operate by utilizing power generated from engine operation. As such, engine driven welders and welding-type apparatus allow portability and thus fill an important need.

Static powered welders initiate the weld process by way of a trigger on a hand-held torch or with an electrically charged stick connected to a charged electrode.

Rotating power driven welders operate similarly, as long as the engine is running. If the engine is shut down, there is typically no residual power to create an arc. To once again weld, the engine must be started and run at operational speed to produce the arc. Therefore, it is simply not possible to manually start and stop the engine between each and every break in the welding process. Further, even during longer periods, operators may find it easier to let the engine run because of distance to the engine, a misconception that it is better for the engine, or just out of habit.

### SUMMARY OF THE INVENTION

In accordance with the present invention, there is provided a system that includes a vehicle that includes a motor to generate a first portion of power and a hydraulic device electronically coupled to the vehicle, wherein the hydraulic device receives the first portion of power for operation. The system further includes a welding device that includes a motor that is a power source that generates a second portion of power to perform a welding operation and a controller that is configured to manage delivery of at least one of the first portion of power or the second portion of power to the hydraulic device.

In accordance with the present invention, there is provided a method that includes at least the following steps: operating a hydraulic device with a first portion of power from a vehicle; generating a second portion of power from a welding device; performing a welding operation with the second portion of power; delivering at least one of the first portion of power or the second portion of power to the hydraulic device integrated with the vehicle based on the vehicle operative state; and operating the hydraulic device integrated with the vehicle with at least one of the first portion of power or the second portion of power.

In accordance with the present invention, there is provided a vehicle that includes at least the following: a front end and a rear end opposite thereof; a motor incorporated into the front end that generates a portion of electrical energy; a hydraulic device incorporated into the rear end; a welding device incorporated into a portion of the rear end; one or more controllers that are configured to manage delivery of the portion of electrical energy to at least one of the welding device or the hydraulic device based on a detected parameter related to at least one of the vehicle, the hydraulic device, or the welding device.

These and other objects of this invention will be evident when viewed in light of the drawings, detailed description and appended claims.

### BRIEF DESCRIPTION OF THE DRAWINGS

The invention may take physical form in certain parts and arrangements of parts, a preferred embodiment of which will be described in detail in the specification and illustrated in the accompanying drawings which form a part hereof, and wherein:

FIG. 1 is a block diagram illustrating a welding device that includes a motor as a power source;

FIG. 2 is a block diagram illustrating a welding device;

FIG. 3 is a block diagram illustrating a welding device affixed to a trailer for mobility;

FIG. 4A is a block diagram illustrating a welding device;

FIG. 4B is a block diagram illustrating a welding device;

FIG. 5 is a block diagram illustrating a hydraulic device integrated with a vehicle to which a portion of electrical power;

FIG. 6 is a block diagram illustrating a system that controls electrical power distribution between a vehicle, a hybrid welder, and a hydraulic device; and

FIG. 7 is a flow diagram of delivering a portion of power from a welding device to a hydraulic device.

### DETAILED DESCRIPTION OF THE INVENTION

Embodiments of the invention relate to methods and systems that generally relate to utilizing a power source of an engine driven welder as a portion of a power supply for a hydraulic device associated with a vehicle. The hydraulic device can be incorporated into a vehicle, a stand-alone device, or a combination thereof. One or more controllers can manage power distribution and identify power sources for the hydraulic device based upon a parameter. In an embodiment, a hydraulic device can be powered by a portion of the engine driven welder based on a manual selection by a user or whether a motor is available (e.g., running). In other embodiments, additional conditions can be evaluated to identify one or more power sources for the hydraulic device.

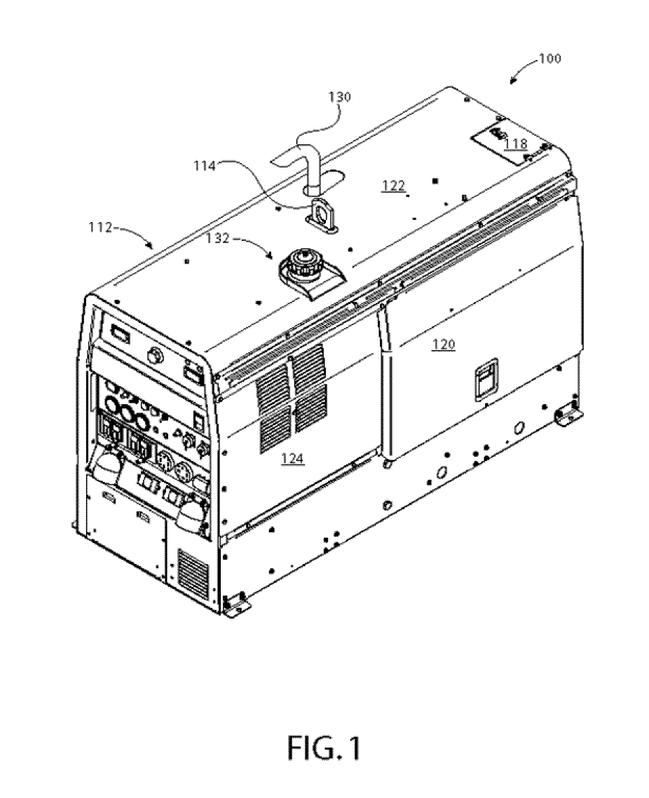

The subject innovation can be used with any suitable engine-driven welder, engine-driven welding system, engine-driven welding apparatus, a welding system powered by an engine, a welding system powered by a battery, a welding system powered by an energy storage device, a hybrid welder (e.g., a welding device that includes an engine driven power source and an energy storage device or batter), or a combination thereof. It is to be appreciated that any suitable system, device, or apparatus that can perform a welding operation can be used with the subject innovation and such can be chosen with sound engineering judgment without departing from the intended scope of coverage of the embodiments of the subject invention. The engine driven welder can include a power source that can be used in a variety of applications where outlet power is not available or when outlet power will not be relied on as the sole source of power including portable power generation, backup power generation, heating, plasma cutting, welding, and gouging. The example discussed herein relates to welding operations, such as, arc welding, plasma cutting, and gouging operations. It is to be appreciated that a power source can generate a portion of power, wherein the portion of power is electrical power. It is to be appreciated that “power source” as used herein can be a motor, an engine, a generator, an energy storage device, a battery, a component that creates electrical power, a component that converts electrical power, or a combination thereof. By way of example and not limitation, FIGS. 1-4 illustrate welding systems or devices that can be utilized with the subject innovation. It is to be appreciated that the following welding systems are described for exemplary purposes only and are not limiting on the welding systems that can utilize the subject innovation or variations thereof.

FIG. 1 illustrates a welding device 100. The welding device 100 includes a housing 112 which encloses the internal components of the welding device. Optionally, the welding type device 100 includes a loading eyehook 114 and/or fork recesses. The loading eyehook 114 and the fork recesses facilitate the portability of the welding device 100. Optionally, the welding-type device 100 could include a handle and/or wheels as a means of device mobility. The housing 112 also includes a plurality of access panels 118, 120. Access panel 118 provides access to a top panel 122 of housing 112 while access panel 120 provides access to a side panel 124 of housing 112. A similar access panel is available on an opposite side. These access panels 118, 120, provide access to the internal components of the welding device 100 including, for example, an energy storage device (not shown) suitable for providing welding-type power. An end panel includes a louvered opening to allow for air flow through the housing 112.

The housing 112 of the welding-type device 100 also houses an internal combustion engine. The engine is evidenced by an exhaust port 130 and a fuel port 132 that protrude through the housing 112. The exhaust port 130 extends above the top panel 122 of the housing 112 and directs exhaust emissions away from the welding-type device 100. The fuel port 132 preferably does not extend beyond the top panel 122 or side panel 124. Such a construction protects the fuel port 132 from damage during transportation and operation of the welding-type device 100.

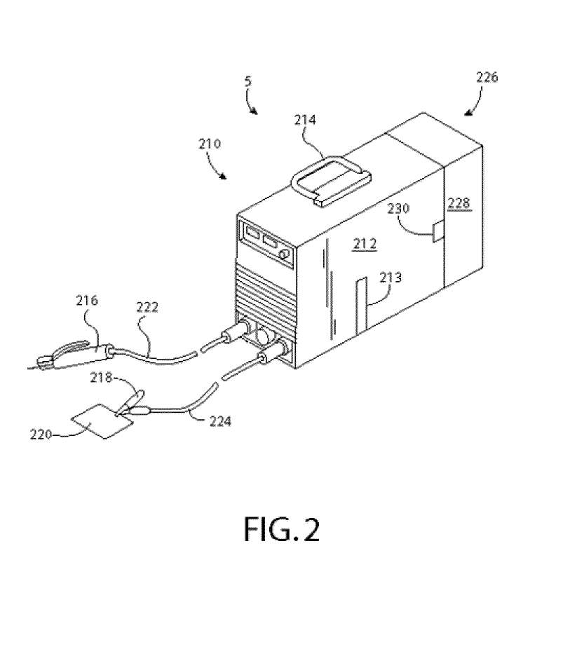

Referring now to FIG. 2, a perspective view of a welding apparatus 205 that can be utilized with the subject innovation. Welding apparatus 205 includes a power source 210 that includes a housing 212 enclosing the internal components of power source 210. As will be described in greater detail below, housing 212 encloses control components 213. Optionally, welding device 210 includes a handle 214 for transporting the welding system from one location to another. To effectuate the welding process, welding device 210 includes a torch 216 as well as a grounding clamp 218. Grounding clamp 218 is configured to ground a workpiece 220 to be welded. As is known, when torch 216 is in relative proximity to workpiece 220, a welding arc or cutting arc, depending upon the particular welding-type device, is produced. Connecting torch 216 and grounding clamp 218 to housing 212 is a pair of cables 222 and 224, respectively.

The welding arc or cutting arc is generated by the power source by conditioning raw power received from an interchangeable energy storage device 226. In a preferred embodiment, energy storage device 226 is a battery. Energy storage device 226 is interchangeable with similarly configured batteries. Specifically, energy storage device 226 is encased in a housing 228. Housing 228 is securable to the housing of welding device 210 thereby forming welding-type apparatus 205. Specifically, energy storage device 226 is secured to power source 210 by way of a fastening means 230. It is contemplated that fastening means 230 may include a clip, locking tab, or other means to allow energy storage device 226 to be repeatedly secured and released from power source 210.

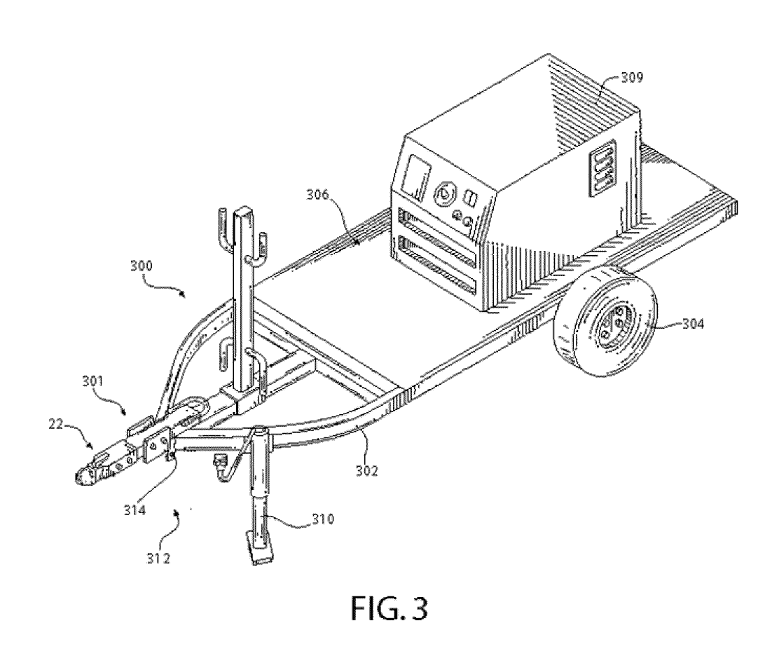

FIG. 3 illustrates a trailer 300 incorporating a trailer hitch or hitching device, depicted generally at 301. The trailer 300 may include a trailer frame 302 and one or more trailer wheels 304 in rotational connection with the trailer frame 302 and may further include a payload region 306 for carrying one or more cargo items, which in an exemplary manner may be a welding power supply 309 or an engine driven welding power supply 309. The trailer 300 may also include an adjustable stand 310 for adjusting the height of the front end 312 of the trailer 300. However, any means may be used for raising and/or lowering the front end 312 of the trailer 300. The trailer hitch 301 may be a generally longitudinal and substantially rigid trailer hitch 301 and may be attached to the frame 302 via fasteners 314, which may be threaded bolts.

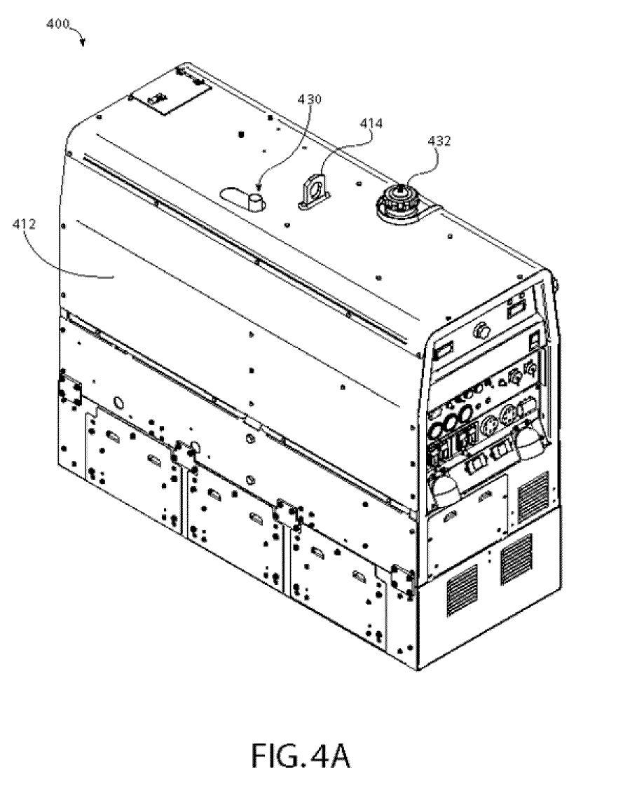

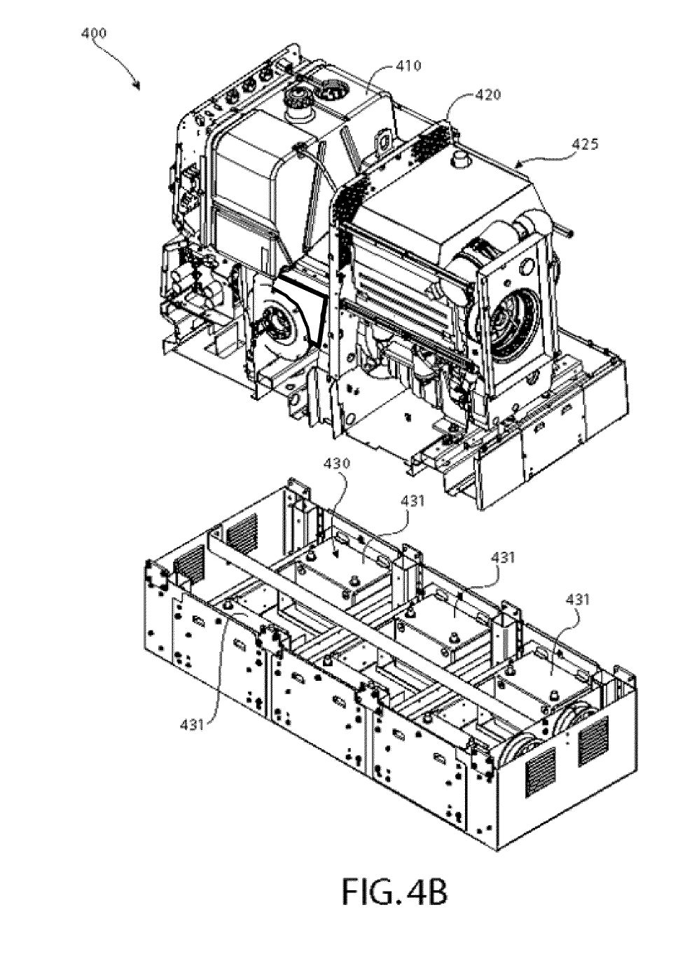

FIGS. 4A and 48 illustrate a hybrid welding device (herein referred to as a “hybrid welder”). A hybrid welder according to the invention is generally indicated by the number 400 in the drawings. Hybrid welder 400 includes an engine component that runs on fuel from fuel storage 410 allowing the hybrid welder 400 to be portable. It will be appreciated that hybrid welder 400 may also be mounted in a permanent location depending on the application. Hybrid welder 400 generally includes a motor-driven welder assembly 420 having a motor 425 and an energy storage device 430. Motor 425 may be an internal combustion engine operating on any known fuel including but not limited to gasoline, diesel, ethanol, natural gas, hydrogen, and the like. These examples are not limiting as other motors or fuels may be used.

The motor 425 and energy storage device 430 may be operated individually or in tandem to provide electricity for the welding operation and any auxiliary operations performed by hybrid welder 400. For example, individual operation may include operating the motor 425 and supplementing the power from the motor 425 with power from the energy storage device 430 on an as needed basis. Or supplying power from the energy storage device 430 alone when the motor 425 is offline. Tandem operation may also include combining power from motor 425 and energy storage device 430 to obtain a desired power output. According to one aspect of the invention, a welder 400 may be provided with a motor having less power output than ordinarily needed, and energy storage device 430 used to supplement the power output to raise it to the desired power output level. In an embodiment, a motor with no more than 19 kW (25 hp) output may be selected and supplemented with six 12 volt batteries. Other combinations of motor output may be used and supplemented with more or less power from energy storage device. The above example, therefore, is not limiting.

Energy storage device 430 may be any alternative power source including a secondary generator, kinetic energy recovery system, or, as shown, one or more batteries 431. In an embodiment, six 12 volt batteries 431 are wired in series to provide power in connection with motor-driven welder assembly 420. Batteries 431 shown are lead acid batteries. Other types of batteries may be used including but not limited to NiCd, molten salt, NiZn, NiMH, Li-ion, gel, dry cell, absorbed glass mat, and the like.

It is to be appreciated that in hybrid welder 400 an alternate power source can be utilized to perform a welding operation. For example, an alternate power source (not shown) and an alternate energy storage device (e.g., energy storage device 430) can be utilized with hybrid welder 400.

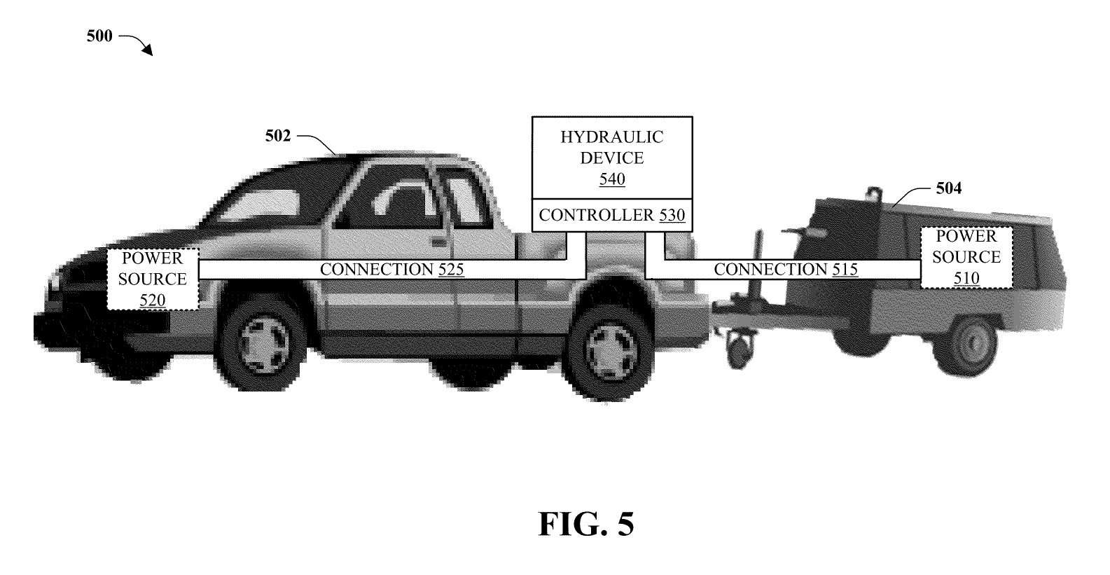

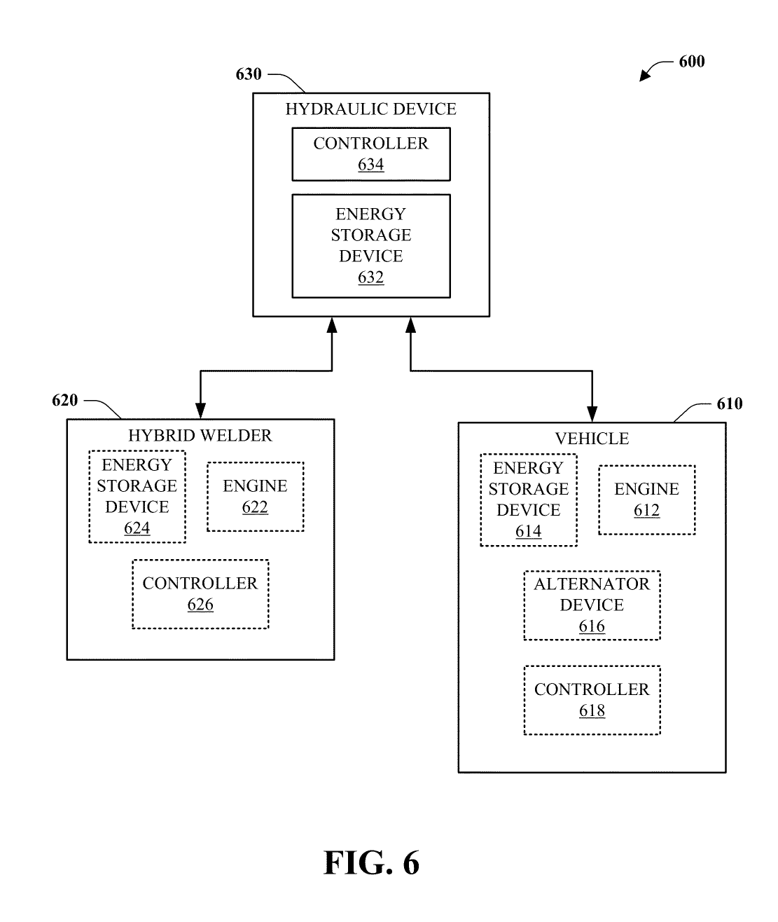

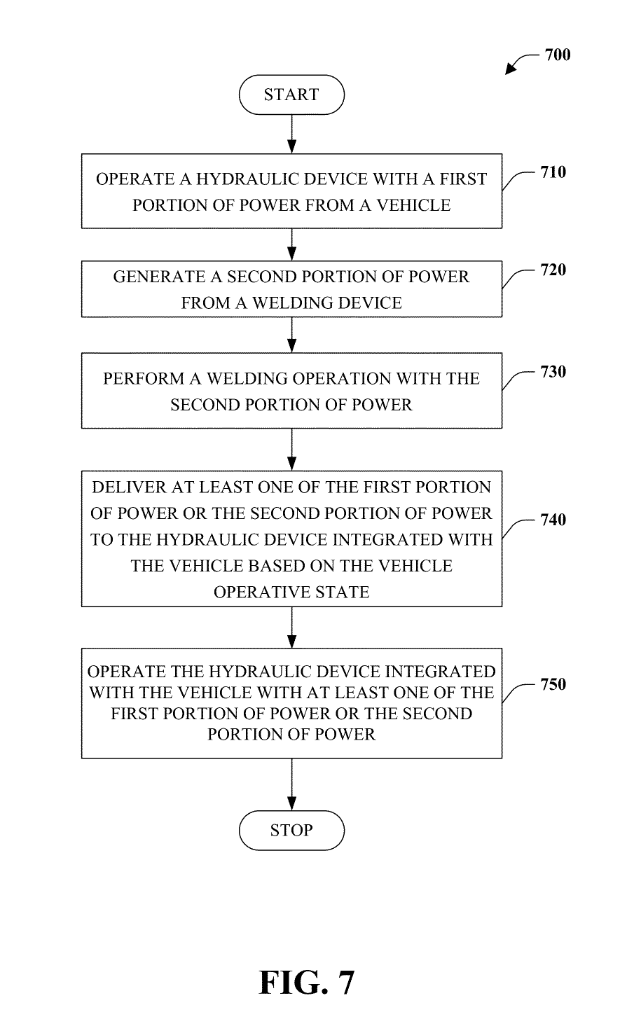

The best mode for carrying out the invention will now be described for the purposes of illustrating the best mode known to the applicant at the time of the filing of this patent application. The examples and figures are illustrative only and not meant to limit the invention, which is measured by the scope and spirit of the claims. Referring now to the drawings, wherein the showings are for the purpose of illustrating an exemplary embodiment of the invention only and not for the purpose of limiting same, FIGS. 5-6 illustrate a schematic block diagram of a welding device, and in particular, an engine driven welding device as discussed in FIGS. 1-4. FIG. 7 illustrates a methodology that can be implemented with one or more welding devices discussed in FIGS. 1-4.

FIG. 5 illustrates system 500 that includes vehicle 502 that is detachably coupled to a trailer that supports welding device 504. An exemplary trailer and welding device 504 is illustrated in FIG. 3 and, as discussed above, various welding devices can be implemented with the subject invention (See FIGS. 1-4). Welding device 504 can include power source 510 that generates a portion of electrical power to perform a welding operation. It is to be appreciated that power source 510 can be any suitable power source or a combination of power sources such as, but not limited to, an engine, an energy storage device, an alternative fuel energy source (e.g., solar, wind, kinetic, among others), a motor, and the like. Moreover, one of sound engineering judgment can chose power source 510 without departing from the intended scope of the subject disclosure. Moreover, it is to be appreciated and understood that the trailer supporting welding device 504 can be detachable via trailer hitch (as depicted), a stand-alone unit, or incorporated into vehicle 520.

Although vehicle 520 is illustrated as a truck or a transport device with two or more axles, it is to be appreciated that the subject innovation is not so limited. For example, a power producing and consuming device can be used with the subject innovation rather than vehicle 520. In an example, equipment such as a tractor, a crane, a loader (e.g., skid steer, all wheel steer, walk-behind mini track, etc.), compact excavator, among others, can be employed with the subject innovation as a power producing and consuming device.

Vehicle 502 can include power source 520 that provides electrical power for use to operate at least vehicle 502 or hydraulic device 540. For instance, vehicle 520 can include an energy storage device that can provide electrical power to actuate a motor. An alternator device (not shown) can further be included with vehicle 520 to convert energy from the motor to additional or supplemental electrical power. In an exemplary embodiment, vehicle 520 can include a combustion engine as power source 520 that uses fuel such as, but not limited to, diesel fuel, gasoline, kerosene, propane, and the like. In another example, vehicle 520 can include one or more power sources such as, but not limited to, an engine, an energy storage device, an alternative fuel energy source (e.g., solar, wind, kinetic, among others), a motor, and the like. For instance, vehicle 520 can be a hybrid vehicle that can include a combustion engine, an energy storage device (e.g., a battery to actuate engine), an alternator, and an additional energy storage device for supplemental electrical power.

System 500 can further include hydraulic device 540 that is incorporated into at least a portion of vehicle 502. Hydraulic device 540 can be, but is not limited to being, a hydraulic tool, a pump, a compressor, a jackhammer, a device that controls a crane, a device that operates a lift, a device that operates a cherry picker, a hydraulic, an elevated work platform, a lift, a support member, a stabilizer, among others. Hydraulic device 540 can be physically coupled to vehicle 502. Moreover, hydraulic device 540 can be electrically coupled to vehicle 502 and welding device 504 via connections (e.g., connection 515 and connection 525). It is to be appreciated that there can be any suitable number of connections to provide electrical power to hydraulic device 540 from vehicle 502 and/or welding device 504 and the depiction of connection 515 and connection 525 is not to be limiting on the subject innovation. Connection 515 can supply the second portion of power from welding device 504 to hydraulic device 540. Connection 525 can supply the first portion of power from vehicle 502 to hydraulic device 540. Connection 515 and connection 525 (herein collectively referred to as “connections”) can include connectors, insulation, couplings, electrical filtering, signal conditioning, electrical conversion, and the like. For instance, a converter component (not shown) can be included with the connections to electrically convert and isolate power received for use with hydraulic device 540. Moreover, connections 515 and 525 can be hard-wired, wireless, detachable, removable, fixed, or a combination thereof. For instance, connection 525 can be fixed, whereas connection 515 can be removable and datable to allow portability of welding device 504 from hydraulic device 540.

Hydraulic device 540 is operated based upon at least a first portion of power supplied by power source 520 or a second portion of power supplied by power source 510. Controller 530 is configured to manage power supply to hydraulic device 540, wherein the power supply can be from power source 510, power source 520, or a combination thereof. In general, controller 530 controls whether to draw electrical power from vehicle 502, welding device 504, or a combination thereof. Controller 530 can be incorporated into hydraulic device 540 (as depicted), a stand-alone component, incorporated into vehicle 502, incorporated into welding device 504, or a combination thereof. Controller 530 can be a portion of hardware, a portion of software, or a combination thereof. For instance, controller 530 can be a processor and a memory that stores one or more instructions (e.g., data) for execution. In another embodiment, controller 530 can be a distributed that includes one or more controllers (discussed in more detail below).

Controller 530 can determine whether to utilize vehicle 502 or welding device 504 for supplying electrical power to hydraulic device 540 based on a parameter (discussed below) or a state of at least one of vehicle 502 or welding device 504. For example, a state for vehicle 502 can be whether vehicle 502 and power source 520 are activated (e.g., in particular a combustion engine as power source 520). For example, a state for welding device 504 can be whether a welding operation is being performed. In an embodiment, the parameter can be a welding parameter. For instance, the welding parameter can be, but is not limited to, a voltage of the welding operation, a current of the welding operation, a portion of a waveform used with the welding operation, a welding schedule parameter (e.g., welding process, wire type, wire size, wire feed speed (WFS), volts, trim, wire feeder to use, feed head to use, among others), a position of a welding tool, a composition of the workpiece on which the welding operation is performed, a position or location of an operator, sensor data (e.g., video camera, image capture, thermal imaging device, heat sensing camera, temperature sensor, among others), an amount of charge stored in an energy storage device, a signal from a controller of the welding operation, a signal from a controller associated with welding device, and the like.

For instance, controller 530 can identify which power source (e.g., power source 520, power source 530, or a combination) based on a parameter. In an embodiment, the parameter can be a switch or a user input. By way of example and not limitation, the parameter can be a switch that allows a first setting to select vehicle 502 to generate the first portion of power to hydraulic device 540 and a second setting to select welding device 504 to generate the second portion of power to hydraulic device 540. Additionally, the switch can include a third setting that selects both vehicle 502 and welding device 504 to supply power to hydraulic device 540.

In another example, the parameter can be associated with vehicle 502. In an embodiment, the parameter is at least one of a representative of the motor of vehicle 502 operating, an amount of energy stored in an energy storage device associated with vehicle 502, a fuel amount contained within vehicle 502, a cost of a fuel for vehicle 502, a fuel consumption efficiency (e.g., miles per gallon, etc.) of vehicle, or a duration of time the motor of vehicle 502 operates. In another example, the parameter is representative of whether vehicle 502 is in motion. In another example, the parameter can be based upon an amount of electrical power an alternator of vehicle 502 generates. One of sound engineering judgment can chose the parameter without departing from the intended scope of the subject innovation.

In the embodiment, the parameter is at least one of a representative of the motor of welding device 504 operating, a representative of the welding operation being performed (e.g., welding, brazing, gouging, TIG, etc.), an amount of energy stored in an energy storage device associated with welding device 504, a fuel amount contained within welding device 504, a cost of a fuel for the motor of the welding device, a fuel consumption efficiency for the welding device, or a duration of time the motor of the welding device operates.

By way of example and not limitation, controller 530 can select welding device 504 to supply the second portion of power to hydraulic device 540 for operation based on the amount of fuel stored in vehicle 502 for an included combustion engine is below a particular threshold. By way of example and not limitation, controller 530 can select welding device 504 to supply the second portion of power to hydraulic device 540 for operation based on a cost of fuel used with combustion engine in vehicle 502 in comparison for a fuel source cost for welding device 504. In such example, fuel costs can be obtained based upon a network connection, an Internet connection, and the like. By way of example and not limitation, controller 530 can select welding device 504 to supply the second portion of power to hydraulic device 540 for operation based on the amount of fuel stored in welding device 504 for an included combustion engine since the amount is above a particular threshold.

In still another example, the parameter can be related to a condition external to vehicle 502 or welding device 504 such as, but not limited to, a geographic location, a temperature, a barometer reading, a humidity level, a weather condition, an altitude, and the like.

FIG. 6 illustrates system 600 that includes vehicle 610, hybrid welder 620 (also referred to as a hybrid welding device), and hydraulic device 630. By way of example and not limitation, system 600 includes a controller for each hydraulic device 630, hybrid welder 620, and vehicle 610. However, it is to be appreciated that any suitable number of controllers can be implemented by the subject innovation and that controllers can be distributed in one or more hosts (e.g., here, one of hydraulic device 630, hybrid welder 620, and/or vehicle 610). For instance, a controller can manage hybrid welder 620 and be hosted or incorporated into hydraulic device 630 and/or vehicle 610. Thus, it is to be appreciated that a controller can be respective to one or more of hydraulic device 630, hybrid welder 620, and vehicle 610.

Vehicle 610 can include an engine 612, an energy storage device 614, and alternator device 616. For instance, vehicle 610 can be a vehicle with two or more axles and a combustion engine. As discussed above, energy storage device 614 can store electrical power to actuate engine 612. Upon actuation of engine 612, alternator device 616 can convert mechanical energy from engine 612 to additional or supplemental electric power. Controller 618 can manage operation of at least one of engine 612, energy storage device 614, alternator device 616, among others. In such depicted system, vehicle 610 includes engine 612 as a primary power source (e.g., power source 520 as depicted in FIG. 5) with energy storage device 612 and alternator device 616 as additional power sources or supplemental power sources. Thus, vehicle 610 generates a first portion of power (e.g., electrical power) that can be delivered to (and/or used by) at least one of the following: vehicle 610; a component incorporated with vehicle 610 (e.g., controller 618, energy storage device 614, radio, electrical system of vehicle, power steering, lights of vehicle, etc.); hybrid welder 620; a component integrated with hybrid welder 620 (e.g., energy storage device 624, processor, controller 626, etc.); a component associated with vehicle 610 (e.g., trailer light system, a device that is connected to a port for charging, etc.); a component associated with hybrid welder 620 (e.g., a device that is charging via a port, etc.); or hydraulic device 630. In particular, the first portion of power can be delivered to hydraulic device 630, wherein the first portion of power is used to operate hydraulic device 630. Moreover, it is to be appreciated that vehicle 610 can include additional energy storage devices (e.g., hybrid vehicle).

Hybrid welder 620 can include one or more power sources such as engine 622 and energy storage device 624. Controller 626 can manage power use for hybrid welder 620 via control of energy storage device 624 and engine 622. Engine 622 can generate a second portion of power (e.g., electrical power) that can be delivered to (and/or used by) at least one of the following: vehicle 610; a component incorporated with vehicle 610 (e.g., controller 618, energy storage device 614, radio, electrical system of vehicle, power steering, lights of vehicle, etc.); hybrid welder 620; a component integrated with hybrid welder 620 (e.g., energy storage device 624, processor, controller 626, etc.); a component associated with vehicle 610 (e.g., trailer light system, a device that is connected to a port for charging, etc.); a component associated with hybrid welder 620 (e.g., a device that is charging via a port, etc.); or hydraulic device 630. In particular, the first portion of power can be delivered to hydraulic device 630, wherein the first portion of power is used to operate hydraulic device 630. Moreover, it is to be appreciated that vehicle 610 can include additional energy storage devices (e.g., hybrid vehicle). In such depicted system, hybrid welder 620 includes engine 622 as a primary power source (e.g., power source 510 as depicted in FIG. 5) with energy storage device 624 as additional power sources or supplemental power sources.

Hydraulic device 630 can include energy storage device 632 that can store a portion of electrical power, wherein the portion of power can be at least one of the first portion of power generated from vehicle 610 or the second portion of power generated from hybrid welder 620. Moreover, controller 634 can be configured to receive and/or deliver the first portion of power (e.g., via a power source from vehicle 610), the second portion of power (e.g., via a power source from hybrid welder 620), or a combination thereof. The delivered or received power (e.g., first portion of power, second portion of power, etc.) can be used to operate hydraulic device 640.

For instance, controller 634 can deliver and/or receive electrical power to operate hydraulic device 640 based on a parameter (as discussed above). In an embodiment, hydraulic device 630 is operated by power from solely hybrid welder 620. In another embodiment, hydraulic device 630 is operated by power from solely vehicle 610. In another embodiment, hydraulic device 630 is operated by power from a combination of hybrid welder 620 and vehicle 610. Moreover, the electrical power can be from one or more sources from either hybrid welder 620 or vehicle 610. For instance, the first portion of power can be from at least one of engine 612, alternator device 616, energy storage device 614, or a combination thereof. In another example, the second portion of power can be from at least one of engine 622, energy storage device 624, or a combination thereof.

In an embodiment, an energy storage device that stores at least one of the first portion of power or the second portion of power. In the embodiment, the energy storage device is incorporated into at least one of the vehicle, the welding device, or the hydraulic device. In an embodiment, the controller manages delivery of at least one of the first portion of power or the second portion of power based on a parameter associated with at least one of the vehicle or the welding device. In the embodiment, the parameter is an electronic signal from a user input.

In the embodiment, the parameter is at least one of an amount of energy stored in an energy storage device associated with the hydraulic device, a type of hydraulic device, a power consumption of the hydraulic device, a duration of time the hydraulic device operates, or a temperature of an environment.

In an embodiment, the hydraulic device is at least one of a hydraulic tool, a pump, a compressor, a jackhammer, a device that controls a crane, a device that operates a lift, a device that operates a cherry picker, or an elevated work platform. In an embodiment, the controller is integrated into one of the welding device, the vehicle, or the hydraulic device.

In an embodiment, the system can include: a first energy storage device integrated with the vehicle, wherein the first energy storage device is configured to receive and store at least one of the first portion of energy or the second portion of energy; a second energy storage device integrated with the welding device, wherein the second energy storage device is configured to receive and store at least one of the first portion of energy or the second portion of energy; and a third energy storage device integrated with the hydraulic device, wherein the third energy storage device is configured to receive and store at least one of the first portion of energy or the second portion of energy.

In an embodiment, the vehicle further comprising an alternator device that converts a portion of mechanical energy from the motor of the vehicle to a portion of electrical energy. In the embodiment, the portion of electrical energy converted by the alternator device is delivered to at least one of the following: an energy storage device integrated with the vehicle; the welding device; an energy storage device integrated with the welding device; the hydraulic device; or an energy storage device integrated with the hydraulic device.

In an embodiment, the system can include a converter component (not shown) that is configured to convert and condition at least one of the first portion of power or the second portion of power for use with the hydraulic device. For instance, the first portion of power and/or the second portion of power can be converted to a particular amperage or voltage associated with hydraulic device 630 to enable use to actuate hydraulic device 630.

In view of the exemplary devices and elements described supra, methodologies that may be implemented in accordance with the disclosed subject matter will be better appreciated with reference to the flow charts and/or methodologies of FIG. 7. The methodologies and/or flow diagrams are shown and described as a series of blocks, the claimed subject matter is not limited by the order of the blocks, as some blocks may occur in different orders and/or concurrently with other blocks from what is depicted and described herein. Moreover, not all illustrated blocks may be required to implement the methods and/or flow diagrams described hereinafter.

Sequentially, the following occurs as illustrated in the decision tree flow diagram 700 of FIG. 7 which is flow diagram 700 that delivers a portion of power from a welding device to a hydraulic device. A hydraulic device is operated with a first portion of power from a vehicle (reference block 710). A second portion of power is generated from a welding device (reference block 720). A welding operation is performed with the second portion of power (reference block 730). At least one of the first portion of power or the second portion of power is delivered to the hydraulic device integrated with the vehicle based on the vehicle operative state (reference block 740). The hydraulic device integrated with the vehicle is operated with at least one of the first portion of power or the second portion of power (reference block 750).

In an embodiment of the method, the hydraulic device is at least one of a hydraulic tool, a pump, a compressor, a jackhammer, a device that controls a crane, a device that operates a lift, a device that operates a cherry picker, or an elevated work platform. In an embodiment, the method can include storing at least one of the first portion of power or the second portion of power in an energy storage device. In an embodiment, the method can include detecting a parameter related to the vehicle and delivering at least one of the first portion of power or the second portion of power to the hydraulic device based on the parameter. In an embodiment, the method can include detecting a parameter related to the welding device and delivering at least one of the first portion of power or the second portion of power to the hydraulic device based on the parameter.

While the embodiments discussed herein have been related to the systems and methods discussed above, these embodiments are intended to be exemplary and are not intended to limit the applicability of these embodiments to only those discussions set forth herein. The control systems and methodologies discussed herein are equally applicable to, and can be utilized in, systems and methods related to arc welding, laser welding, brazing, soldering, plasma cutting, waterjet cutting, laser cutting, and any other systems or methods using similar control methodology, without departing from the spirit or scope of the above discussed inventions. The embodiments and discussions herein can be readily incorporated into any of these systems and methodologies by those of skill in the art. By way of example and not limitation, a power supply as used herein (e.g., welding power supply, among others) can be a power supply for a device that performs welding, arc welding, laser welding, brazing, soldering, plasma cutting, waterjet cutting, laser cutting, among others. Thus, one of sound engineering and judgment can choose power supplies other than a welding power supply departing from the intended scope of coverage of the embodiments of the subject invention.

The above examples are merely illustrative of several possible embodiments of various aspects of the present invention, wherein equivalent alterations and/or modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component, such as hardware, software, or combinations thereof, which performs the specified function of the described component (e.g., that is functionally equivalent), even though not structurally equivalent to the disclosed structure which performs the function in the illustrated implementations of the invention. In addition although a particular feature of the invention may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising.”

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that are not different from the literal language of the claims, or if they include equivalent structural elements with insubstantial differences from the literal language of the claims.

The best mode for carrying out the invention has been described for purposes of illustrating the best mode known to the applicant at the time. The examples are illustrative only and not meant to limit the invention, as measured by the scope and merit of the claims. The invention has been described with reference to preferred and alternate embodiments. Obviously, modifications and alterations will occur to others upon the reading and understanding of the specification. It is intended to include all such modifications and alterations insofar as they come within the scope of the appended claims or the equivalents thereof.

What is claimed is:

1. A system, comprising:
a vehicle that includes a motor to generate a first portion of power;
a hydraulic device electronically coupled to the vehicle, wherein the hydraulic device receives the first portion of power for operation;
a welding device that includes a motor that is a power source that generates a second portion of power to perform a welding operation; and
a controller that is configured to manage delivery of at least one of the first portion of power or the second portion of power to the hydraulic device.

2. The system of claim 1, further comprising an energy storage device that stores at least one of the first portion of power or the second portion of power.

3. The system of claim 2, wherein the energy storage device is incorporated into at least one of the vehicle, the welding device, or the hydraulic device.

4. The system of claim, 1, wherein the controller manages delivery of at least one of the first portion of power or the second portion of power based on a parameter associated with at least one of the vehicle or the welding device.

5. The system of claim 4, wherein the parameter is an electronic signal from a user input.

6. The system of claim 4, wherein the parameter is at least one of a representative of the motor of the vehicle operating, an amount of energy stored in an energy storage device associated with the vehicle, a fuel amount contained within the vehicle, a cost of a fuel for the vehicle, a fuel consumption efficiency of the vehicle, or a duration of time the motor of the vehicle operates.

7. The system of claim 4, wherein the parameter is at least one of a representative of the motor of the welding device operating, a representative of the welding operation being performed, an amount of energy stored in an energy storage device associated with the welding device, a fuel amount contained within the welding device, a cost of a fuel for the motor of the welding device, a fuel consumption efficiency for the welding device, or a duration of time the motor of the welding device operates.

8. The system of claim 4, wherein the parameter is at least one of an amount of energy stored in an energy storage device associated with the hydraulic device, a type of hydraulic device, a power consumption of the hydraulic device, a duration of time the hydraulic device operates, or a temperature of an environment.

9. The system of claim 1, wherein the hydraulic device is at least one of a hydraulic tool, a pump, a compressor, a jackhammer, a device that controls a crane, a device that operates a lift, a device that operates a cherry picker, or an elevated work platform.

10. The system of claim 1, wherein the controller is integrated into one of the welding device, the vehicle, or the hydraulic device.

11. The system of claim 1, further comprising:
a first energy storage device integrated with the vehicle, wherein the first energy storage device is configured to receive and store at least one of the first portion of energy or the second portion of energy;
a second energy storage device integrated with the welding device, wherein the second energy storage device is configured to receive and store at least one of the first portion of energy or the second portion of energy; and
a third energy storage device integrated with the hydraulic device, wherein the third energy storage device is configured to receive and store at least one of the first portion of energy or the second portion of energy.

12. The system of claim 1, wherein the vehicle further comprising an alternator device that converts a portion of mechanical energy from the motor of the vehicle to a portion of electrical energy.

13. The system of claim 12, wherein the portion of electrical energy converted by the alternator device is delivered to at least one of the following:
an energy storage device integrated with the vehicle;
the welding device;
an energy storage device integrated with the welding device;
the hydraulic device; or
an energy storage device integrated with the hydraulic device.

14. The system of claim 1, further comprising a converter component that is configured to convert and condition at least one of the first portion of power or the second portion of power for use with the hydraulic device.

15. A method, comprising:
operating a hydraulic device with a first portion of power from a vehicle;
generating a second portion of power from a welding device;
performing a welding operation with the second portion of power;
delivering at least one of the first portion of power or the second portion of power to the hydraulic device integrated with the vehicle based on the vehicle operative state; and
operating the hydraulic device integrated with the vehicle with at least one of the first portion of power or the second portion of power.

16. The method of claim 15, wherein the hydraulic device is at least one of a hydraulic tool, a pump, a compressor, a jackhammer, a device that controls a crane, a device that operates a lift, a device that operates a cherry picker, or an elevated work platform.

17. The method of claim 15, further comprising storing at least one of the first portion of power or the second portion of power in an energy storage device.

18. The method of claim 15, further comprising:
detecting a parameter related to the vehicle; and
delivering at least one of the first portion of power or the second portion of power to the hydraulic device based on the parameter.

19. The method of claim 15, further comprising:
detecting a parameter related to the welding device; and
delivering at least one of the first portion of power or the second portion of power to the hydraulic device based on the parameter.

20. A vehicle, comprising:
a front end and a rear end opposite thereof;
a motor incorporated into the front end that generates a portion of electrical energy;
a hydraulic device incorporated into the rear end;
a welding device incorporated into a portion of the rear end; and
one or more controllers that are configured to manage delivery of the portion of electrical energy to at least one of the welding device or the hydraulic device based on a detected parameter related to at least one of the vehicle, the hydraulic device, or the welding device.
